(19) United States
(12) Patent Application Publication
(10) Pub. No.: US 2001/0031438 A1
(43) Pub. Date: Oct. 18, 2001

(54) Candle manufacturing and candles

(76) Inventors: Paul Hannington, Norfolk (GB); Michael Harris, Norfolk (GB); Clare Ewin, Norfolk (GB)

Correspondence Address: PEPPER HAMILTON LLP, 600 Fourteenth Street, N.W., Washington, DC, 20005-2004, US

(21) Appl. No.: 09/758,149

(22) Filed: Jan. 12, 2001

(30) Foreign Application Priority Data
Jan. 14, 2000 (GB) 0000911.8

(51) Int. Cl. C11C 5/00; B29C 35/16; F23D 3/16

(52) U.S. Cl. 431/288; 264/40.1; 264/40.6

(57) ABSTRACT

A thermochromic colourant is used to indicate a temperature change in a candle. During manufacture, the colour change of the colourant will indicate when the temperature has fallen to a level suitable for packing of the candle. The candle formulation may include the thermochromic colourant to visually indicate when in use parts of the candle above a predetermined temperature, or the colourant may be provided in a coating on the candle body, or in a wrapper for the candle.

### INTRODUCTION AND BACKGROUND

This invention relates to candles and manufacturing processes therefore and in particular to indicating and monitoring the temperature of a candle during its manufacture and use. It is particularly concerned with wax candles.

In a container candle the candle wax is held within a container, usually glass. The manufacture of container candles is usually carried out by a “core method” comprising a candle core formation stage. In this core method a molten candle formulation is prepared; typically this is a molten wax mixture at a temperature of approximately 60° C. - 65° C. Part of this molten formulation is poured into moulds and cooled until set, to provide a candle core. A hole is drilled centrally in each core and a wick is threaded through the hole. The candle core, thus prepared, is placed into the candle container and a further part of the molten candle formulation is used to fill, or partially fill the container to provide a candle with the desired weight, volume, or fill height. Once this “top-up” candle formulation has cooled sufficiently the resulting candle is packaged for despatch. Using this method a candle is manufactured using an essentially two stage process.

A simpler single stage process may be used as an alternative to the coring process. In this the molten candle formulation is simply poured into a container and allowed to set.

These manufacturing processes present various difficulties, particularly when packaging the candles after production.

The hot molten wax contracts as it cools and solidifies. If candles are packed without being sufficiently cooled air pockets may appear in the wax, the wax can become detached from the sides of the container and shrinkage of the wax can result in a uneven surface. Cracking, which is aesthetically displeasing, can also result from contraction of the wax on cooling.

Secondly, whilst the wax is heated above normal room temperatures, candles including fragrance in the formulation suffer an increased perfume vaporisation rate. It is therefore desirable that cooling to normal temperatures is conducted in a rapid and effective manner, to prevent prolonged loss of fragrance oils.

A further difficulty arises when the wax is inadequately cooled prior to packing, when condensation can result, particularly if the packaged product is stored in relatively cooler conditions prior to despatch. This condensation can prove unsightly and, if present in sufficient quantities can damage the packaging, distorting cardboard and causing print colours to run.

Measuring wax temperature using traditional thermometers is unsatisfactory as the temperature at only a single point on the surface of the candle may be measured at any one time. Furthermore, any intrusion into the candle surface by a thermometer tends to damage the candle's appearance. Traditional temperature measurement methods are also relatively slow and not suitable for high speed container candle manufacture.

For safety reasons it is also desirable to be able to provide some indication to a user of a candle that the candle wax is still hot even though the candle itself may have been extinguished. Finally, there is the general problem of how technical means as opposed to, for example, sculpting, can be used to provide a candle with a more interesting and attractive appearance.

A candle with changeable flame colours is known from CN 1 099 791A and a thermally colour-changing candle holder is known from U.S. Pat. No. 4,818,215A (equivalent to GB 2 204 120B), but neither of these disclosures are of assistance for the above problems.

### SUMMARY OF THE INVENTION

The above needs are addressed according to the present invention by using a thermochromic colourant or pigment to indicate visually when a candle, or a part thereof, is above or below a predetermined temperature. The candle itself may be formed from a formulation including a thermochromic colourant to indicate visually parts of the candle above a predetermined temperature. However, the thermochromic colourant may be incorporated in a sleeve or packaging in thermal contact with the candle or in an overdip or coating applied to the candle.

Other aspects the invention also include a candle manufacturing process using a thermochromic colourant, and use of a thermochromic colourant to monitor a candle manufacturing process.

The thermochromic colourant provides a straightforward way of checking the temperature of the candle formulation to determine whether or not it is ready for further processing. Thus operators can decide, by simple visual inspection, when a candle is ready for packaging. Moreover, rather than relying on a temperature measurement made at one particular point on a candle's surface, an operator can instead check substantially the entire candle surface simply by looking for a uniform coloration.

In a preferred embodiment the colourant is provided in the candle formulation and the proportion of thermochromic colourant preferably comprises less than 1% by weight of the candle formulation, more preferably, less than 0.2% by weight, and advantageously approximately 0.1% by weight of the formulation.

The thermochromic colourant preferably changes colour at a relatively well defined temperature. To indicate the candle's suitability for packing this temperature is preferably in the range 20° C. to 40° C., more preferably between 20° C. and 35° C., and most preferably, for wax, around 25° C.

It will be appreciated that the preferred temperature will, in part, depend upon the composition of the candle formulation. For providing a safety indication warning of hot wax, different temperature ranges are generally preferable. Thus the colour change temperature may be selected to approximately correspond to the melting point of the candle formulation. For wax this temperature typically lies between 50° C. and 80° C. For monitoring other parts of the candle manufacturing process, for example the temperature of the molten wax prior to pouring/core formation, yet further temperature ranges are preferred. For example, as described above a molten wax mixture is typically prepared at around 65° C. and the thermochromic colourant can be chosen to indicate, or guarantee, that the molten candle formulation is above a certain temperature (65° C. in the above example). Chromicolour 60 may be used for this purpose (red at 53° C., colourless at 65° C.).

The candle formulation is not restricted to wax but may also comprise as the or a main component paraffin wax or paraffin wax/organic acid mixtures.

Additionally transparent candles comprise thermoplastic polymers, and hydrocarbon oil/thermoplastic polymer mixtures. The colour change temperature of the thermochromic colourant can be chosen to indicate visually the temperature of the candle at packaging or during intermediate process steps, for example, before, during or after a candle core formation stage of the manufacturing process. The type and quantity of thermochromic colourant may be varied depending upon the temperature range required.

In yet another preferred embodiment a thermochromic colourant is incorporated in packaging for a candle body. For example, the colourant may be incorporated in or on a sleeve of material which surrounds a glass container or the like in which the candle body is formed, so as to be in thermal contact with the candle body. Heat from the cooling candle body will be transferred to the sleeve via the glass container and so a change of colour of the colourant will indicate that the temperature of the candle body has fallen to a required level. The colourant may be printed onto the sleeve using an ink containing a thermochromic colourant.

In yet another preferred embodiment, a sleeve which is applied direct to the candle will contain the thermochromic colourant or be painted with the thermochromic colourant containing ink.

The thermochromic colourant may also be included in an overdip or coating which is typically applied to a free standing candle.

When the packaging remains in place during candle burning, or use, it should be resistant to heat. With a sleeve applied directly to the candle body, the sleeve might be removed before use, or otherwise may melt with the candle wax.

### BRIEF DESCRIPTION OF THE DRAWINGS

These and other aspects of the present invention will now be further described, by way of example only, with reference to the accompanying figures in which:

FIG. 1 shows a vertical cross-section through a thermochromic container candle;

FIG. 2 shows, diagramatically, a candle manufacturing process for manufacturing the candle of FIG. 1;

FIG. 3 shows a container candle partly cut away having a sleeve which incorporates a thermochromic colourant.

FIG. 4 shows a candle, partly cut away, having a sleeve applied direct to the surface of the candle body, and

FIG. 5 shows a candle having a layer or coating applied to the candle body.

### DESCRIPTION OF THE PREFERRED EMBODIMENTS

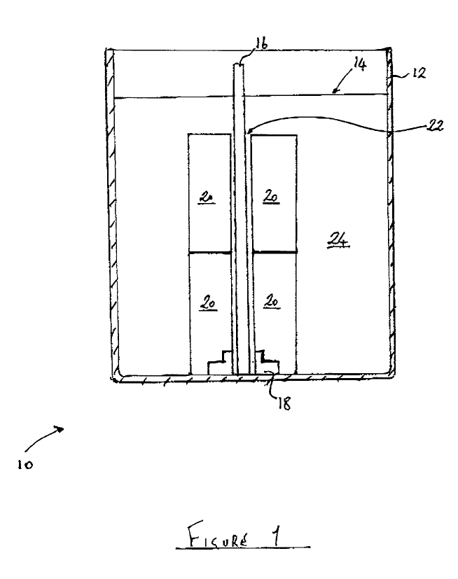

Referring firstly to FIG. 1, a thermochromic container candle is generally illustrated at 10, and comprises a container 12, usually made from glass, holding a candle body 14. Candle body 14 comprises a wick 16 held centrally by a sustainer 18. The candle body comprises one or more candle cores 20, drilled to provide an opening 22 to receive wick 16. During manufacture “top-up” wax 24 is used to fill or partially fill container 12.

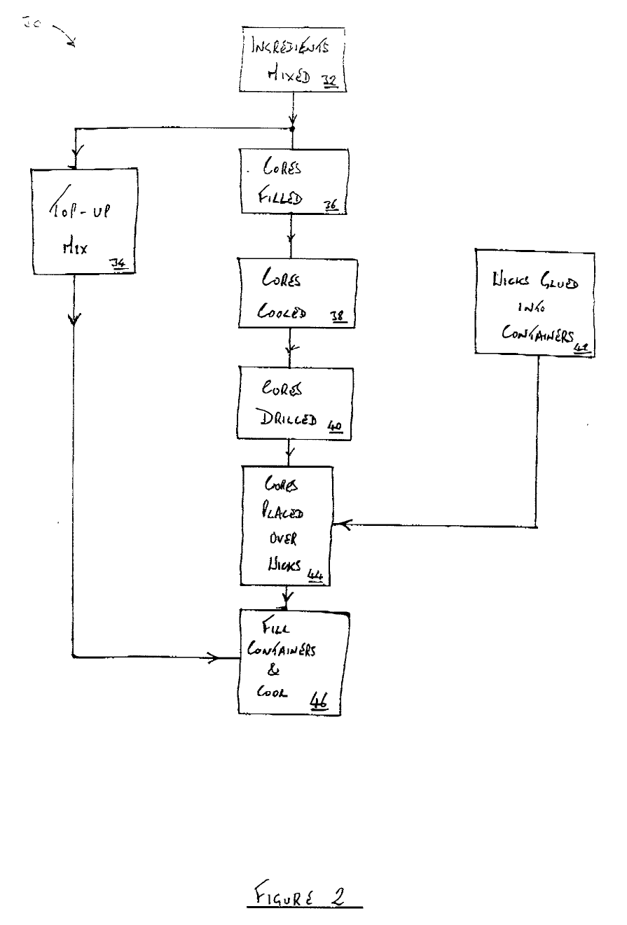

FIG. 2 shows a simplified flowchart for a candle manufacturing process. Initially, at step 32, a molten mixture of the ingredients of the candle formulation is prepared. This mixture is used for the cores and for the “top-up” mix 34. At step 36 the molten formulation is poured into core moulds and cooled 38 until set. The cores are then drilled 40 to receive a wick. Wicks are fastened within the containers by means of a metal sustainer which is glued in place (as shown in FIG. 1). at step 42 and then, at step 44, one or more drilled cores are placed over each wick. The top-up mix is then used to fill the container tip to the desired level, step 46, and the candle is allowed to cool before being packaged for despatch. At step 46, the candle body can be visually monitored to observe the colour change in the thermochromic colourant in the candle body formulation, to determine that the candle body has cooled sufficiently to be packed for shipment, etc.

In a preferred embodiment the thermochromic colourant is a leuco colourant which exhibits thermochromism, that is it exhibits a colour change with temperature. (Although “colour” is usually used to refer to the appearance of an object to the naked eye, the term is not limited to this and includes changes of the appearance of the object in non-visual parts of the spectrum including the infra-red and ultra-violet spectral regions).

A preferred thermochromic colourant is “Fast Blue (G-O) as sold by the Matsui International Company Limited of Japan under the Chromicolour (®) name. This is a blue colourant which when incorporated into a wax remains blue at temperatures below around 25° C. but becomes substantially colourless at temperatures above this. When the candle body is above 25° C. the colourant colour ‘disappears’, but returns again once the colourant is cooled to below 25° C.

In the above described manufacturing processes the thermochromic colourant is added to the molten wax used for filling (during the single stage process) and/or used for one or more of the coring stage and the top-up stage (in the two stage manufacturing process). The applicants have determined by experiment that when used in this way, providing the external colour of a manufactured container candle (or candle core) is substantially uniform, the temperature in the middle of the wax inside the containers whilst being a little higher than the external temperature, is sufficiently low to reduce or eliminate the problems outlined above. Thus the temperature, and hence the point in time, at which the cores are ready to be used or at which the finished candles are ready to be packed, can readily be determined.

The colour of a manufactured candle will be in part determined by the colour of the thermochromic colourant. If desired, the candle formulation may include other colourants, primary colours or otherwise, to achieve a wide palate of potential colours and colour variations. Thus a second colourant may be added to the candle formulation to provide improved visibility of the colour change, for example to assist colour-blind operators of the manufacturing process or users of the manufactured candles.

Using a thermochromic colourant in the candle manufacturing process results in a thermochromic candle. Such a candle changes colour when lit as the candle flame increases the temperature of the wax; this provides a pleasing aesthetic effect. The degree of colour change depends upon the size of the candle, the temperature at which the wax burns and the temperature which the thermochromic colourant switches.

When the candle is extinguished the candle wax in due course cools and the original colour of the candle returns. By choosing the thermochromic colourant so that the colour switch only occurs when the wax is molten, a candle can be provided which indicates when molten wax is present and hence provides an indication of when there is risk of burns and wax spillage. By selecting a colourant with a lower switching temperature a greater margin of safety can be provided, for example, for candles for children.

Table 1 gives the compositions of four candle formulations embodying aspects of the present invention.

TABLE 1

| | Candle composition (% w/w) | | | |
|---|---|---|---|---|
| Ingredient | 1 | 2 | 3 | 4 |
| Paraffin Wax^{a} (_{XP300)} | to 100.00 | to 100.00 | to 100.00 | 0 |
| Stearic acid^{b} | 0 | 15 | 15 | 0 |
| Chromocolour Fast | 0.1 | 0.1 | 0.1 | 0.1 |
| Blue^{c} | | | | |
| Solvent Red^{d} | 0 | 0 | 0.1 | 0.1 |
| Perfume^{e} | 6.00 | 0.00 | 8.00 | 4.00 |
| Versagel CMP^{f} | 0 | 0 | 0 | to 100.00 |

^{a}Available from Eggar and Co.
^{b}Available from Ellis & Everard
^{c}Available from Matsui International Company
^{d}Available from Hoechst
^{e}Available from Quest
^{f}A gelled mineral oil by Penreco of Dickinson. Texas, available from The Biomar Company

Formulation 1 is for a fragranced, blue coloured candle; formulation 2 is for an unfragranced, blue coloured candle, and includes an organic acid to increase the burning time as compared with formulation 1. Formulation 3 is a fragranced candle formulation with the addition of a secondary colour to produce, in the example shown, a purple coloured candle. When the candle is too hot, (or when the wax is molten) the candle will appear red in colour. Formulation 4 is a gel candle, similar to formulation 3, but instead of paraffin wax it uses Versagel CMP as a candle base material, this is almost completely transparent.

Other suitable thermochromic colourants which are available from Clark R & D, USA include:

| | Colour Change on | |
|---|---|---|
| Name | Cooling | Temperature of Change |
| Colourtell 27 PW Fast | light blue to dark blue | 35° C. |
| Blue | | |
| Colourtell 27 PW Fast | light yellow to dark | 45° C. |
| Yellow | yellow | |
| Colourtell 27 PW Pink | light pink to pink | 40° C. |
| Colourtell 27 PW | pale red to orange/red | 40° C. |
| Vermillion | | |

In general, candle formulations may include any or all of natural perfume oil extracts, UV absorbers, glitters, pearlisers and beeswax. It is not normally necessary to use the thermochromic colourant at concentrations of greater than 1% w/w in the formulations.

Although the use of a thermochromic colourant has been described in the context of container candles, the concept is also applicable to other types of candles such as free-standing candles, church candles, votives and tealights. Similarly containers used for container candles are not limited to glass but may comprise a variety of non-combustible materials such as metals, ceramic and terracotta.

In FIG. 3, a container candle is formed from a typical wax or gel composition forming a candle body 50 which is held in a glass container 52. A sleeve 54, which is shown with an exaggerated thickness for clarity, is fitted around container 52. Sleeve 54 may be taped in place, glued, shrink-fitted or the like as well known in the art. Sleeve 54 incorporates a thermochromic colourant. This may be absorbed or otherwise incorporated in the sleeve or it may be printed on the sleeve. Sleeve 54 is in thermal contact with the candle body 50 via the glass container 52. As the candle body 50 cools, the colourant incorporated in or on sleeve 54 will change at the predetermined transition temperature. Referring to the method of FIG. 2, in the manufacturing process, the core or top up mix need not include a thermochromic colourant as the sleeve is provided on the container of step 46.

If the sleeve 54 is to remain in place during burning of the candle by the consumer, then it should be made of a material which is resistant to the heat generated during the burning process.

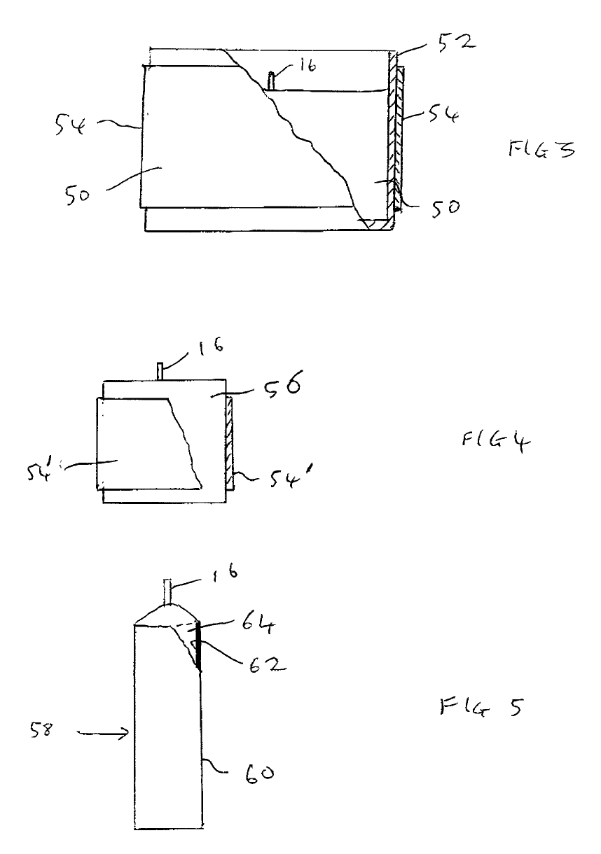

In the embodiment of FIG. 4, a free standing candle body 56 has a sleeve 54′ fitted around its periphery, similar to sleeve 54 of the embodiment of FIG. 3. The sleeve 54′ may be applied when the candle 56 has sufficient integrity to receive the sleeve but is still at an elevated temperature. Free standing candle bodies may be moulded or extruded, for example, with the wick in place.

In the embodiment of FIG. 5, a free standing pillar candle 58 has a candle body 64 which is formed by extrusion. The candle body 64 has a coating 60 applied to the outer surface 62 of the candle body 64 by dipping the candle body, as is well known in the art. In this case the ‘overdip’ material used to coat the candle body 64 contains a blue coloured thermochromic colourant, available as DCE2323 from Dussek Campbell, UK, which is colourless above 40° C. and blue below that temperature. The hot candle body 64 can be dipped in the molten overdip material and removed. A colour change of the coating from colourless to blue will indicate that the candle body has cooled to the required pre-packing temperature.

The skilled person will appreciate that the invention is not limited to the described embodiments.

What we claim is:

1. A method of manufacturing a candle, the method including the steps of:
providing a candle formulation,
forming a candle body from the candle formulation at an elevated temperature, and
allowing the candle body to cool,
wherein a thermochromic colourant which changes colour at a predetermined temperature or temperature range is provided and is maintained in thermal contact with the candle body, and
monitoring the change of colour of the colourant to determine when the candle body has cooled below the predetermined temperature or temperature range.

2. A method as claimed in claim 1, wherein the thermochromic colourant is incorporated in the candle formulation.

3. A method as claimed in claim 1, wherein the thermochromic colourant is incorporated in a coating applied to the candle body.

4. A method as claimed in claim 1 wherein the thermochromic colourant is incorporated in or on a wrapping applied to the candle body.

5. A method as claimed in claim 1, wherein the thermochromic colourant is incorporated in or on a container for the candle body.

6. A method as claimed in claim 2, wherein a surface portion of the candle body is inspected for substantially uniform colouration to determine the suitability of the candle for further processing, such as packaging.

7. A method as claimed in claim 2, wherein wherein the proportion of thermochromic colourant comprises less than 1% by weight of the candle formulation.

8. A method as claimed in claim 7, wherein the proportion of thermochromic colourant comprises less than 0.2% by weight of the candle formulation.

9. A method as claimed in claim 1, wherein the thermochromic colourant is a leuco colourant.

10. A method as claimed in claim 2, wherein the candle formulation includes a second colourant.

11. A method as claimed in claim 2, wherein a main component of the candle formulation is selected from wax, paraffin wax and a thermoplastic polymer.

12. A method as claimed in claim 1, wherein the thermochromic colourant changes colour at a temperature in this range 20° C. to 35° C.

13. A method as claimed in claim 1, wherein the manufacturing process comprises forming a candle core containing the thermochromic colourant, and the candle core colour is inspected to determine its readiness for further processing.

14. A method as claimed in claim 3, wherein the coating is inspected for substantially uniform colouration to determine the suitability of the candle for further processing, such as packaging.

15. A candle manufacturing process comprising:
preparing a candle formulation including a proportion of thermochromic colourant; and
including the step of inspecting the colour of the formulation to determine a temperature range of the formulation.

16. A candle manufacturing process as claimed in claim 15, wherein an upper or lower limit to the temperature of at least a portion of the candle formulation is determined by inspecting the colour of the candle formulation.

17. A candle including a thermochromic colourant in thermal contact with a body of the candle to visually indicate when a part of the candle body is above a predetermined temperature.

18. A candle as claimed in claim 1, wherein the predetermined temperature lies in the range of 40° C. to 70° C.

19. A candle as claimed in claim 17, wherein the predetermined temperature lies in the range 20° C. to 40° C.

20. A candle as claimed in claim 17, wherein the predetermined temperature is substantially equal to the temperature at which the formulation of the candle body melts.

21. A candle as claimed in claim 17, wherein a wrapping is provided in thermal contact with the candle body, and the wrapping includes a thermochromic colourant.

22. A candle as claimed in claim 17, wherein a conatiner is provided, the candle body being housed in the container, and the a thermochromic colourant is provided on an outer surface of the container and in thermal contact with the candle body via the container.

23. A candle as claimed in claim 22, wherein a wrapping or sleeve is provided on the container, and the thermochromic colourant is provided in or on the sleeve.

24. A candle as claimed in claim 17, wherein the thermochromic colourant is provided in the candle body.
